(19) United States
(12) Patent Application Publication
(10) Pub. No.: US 2018/0336045 A1
(43) Pub. Date: Nov. 22, 2018

(54) DETERMINING AGENTS FOR PERFORMING ACTIONS BASED AT LEAST IN PART ON IMAGE DATA

(71) Applicant: Google Inc., Mountain View, CA (US)

(72) Inventor: Ibrahim Badr, Zürich (CH)

(21) Appl. No.: 15/603,092

(22) Filed: May 23, 2017

Related U.S. Application Data
(60) Provisional application No. 62/507,606, filed on May 17, 2017.

(51) Int. Cl. G06F 9/44; G06K 9/00

(52) U.S. Cl. CPC G06F 9/4446; G06K 9/00624

(57) ABSTRACT

An assistant is described that selects, based at least in part on image data received from a camera of a computing device, a recommended agent from a plurality of agents to perform one or more actions associated with the image data. The assistant determines whether to recommend that the assistant or the recommended agent perform the one or more actions associated with the image data and responsive to determining to recommend that the recommended agent perform the one or more actions associated with the image data, outputs an indication of the recommended agent. Responsive to receiving the user input confirming the recommended agent, the assistant causes the recommended agent to at least initiate performance of the one or more actions associated with the image data.

### RELATED APPLICATION

This application claims the benefit of U.S. Provisional Patent Application No. 62/507,606, filed May 17, 2017, the entire content of which is hereby incorporated by reference.

### BACKGROUND

Some computing platforms may provide a user interface from which a user can chat, speak, or otherwise communicate with a virtual, computational assistant (e.g., also referred to as “an intelligent personal assistant” or simply as an “assistant”) to cause the assistant to output useful information, respond to a user's needs, or otherwise perform certain operations to help the user complete a variety of real-world or virtual tasks. For instance, a computing device may receive, with a microphone or camera, user input (e.g., audio data, image data, etc.) that corresponds to a user utterance or user environment. An assistant executing at least in part at the computing device may analyze a user input and attempt to “assist” a user by outputting useful information based on the user input, responding to the user's needs indicated by the user input, or otherwise perform certain operations to help the user complete a variety of real-world or virtual tasks based on the user input.

### SUMMARY

In general, techniques of this disclosure may enable an assistant to manage multiple agents for taking actions or performing operations based at least in part on image data obtained by the assistant. The multiple agents may include one or more first-party (1P) agents included within the assistant and/or share a common publisher with the assistant and/or one or more third-party (3P) agents associated with applications or components of the computing device that are not part of the assistant or do not share a common publisher with the assistant. After receiving explicit and unambiguous permission from a user to make use of, store, and/or analyze personal information of the user, a computing device may receive, with an image sensor (e.g., camera), image data that corresponds to a user environment. An agent selection module may analyze the image data to determine, based at least in part on content in the image data, one or more actions that a user is likely to want to have performed given the user environment. The actions may be performed either by the assistant or by a combination of one or more agents from a plurality of agents that are managed by the assistant. The assistant may determine whether to recommend that the assistant or the recommended agent(s) perform the one or more actions and output an indication of the recommendation. Responsive to receiving user input confirming or changing the recommendation, the assistant may perform, initiate, invite, or cause the agents(s) to perform, the one or more actions. In this way, the assistant is configured to not only determine actions that may be appropriate for a user's environment, but also, recommend an appropriate actor for performing the action. Accordingly, the described techniques may improve usability with an assistant by reducing the quantity of user inputs required for a user to discover, and cause the assistant to perform, various actions.

In one example, the disclosure is directed to a method that includes receiving, by an assistant accessible by a computing device, image data from a camera of the computing device, selecting, by the assistant, based on the image data and from a plurality of agents accessible from the computing device, a recommended agent to perform one or more actions associated with the image data, and determining, by the assistant, whether to recommend that the assistant or the recommended agent perform the one or more actions associated with the image data. The method further includes responsive to determining to recommend that the recommended agent perform the one or more actions associated with the image data, causing, by the assistant, the recommended agent to at least initiate performance of the one or more actions associated with the image data.

In another example, the disclosure is directed to a system that includes means for receiving image data from a camera of a computing device, selecting, based on the image data and from a plurality of agents accessible from the computing device, a recommended agent to perform one or more actions associated with the image data, and determining whether to recommend that an assistant or the recommended agent perform the one or more actions associated with the image data. The system further includes means for responsive to determining to recommend that the recommended agent perform the one or more actions associated with the image data, causing the recommended agent to at least initiate performance of the one or more actions associated with the image data.

In another example, the disclosure is directed to a computer-readable storage medium that includes instructions that when executed by one or more processors of a computing device, cause the computing device to receive image data from a camera of the computing device, select, based on the image data and from a plurality of agents accessible from the computing device, a recommended agent to perform one or more actions associated with the image data, and determine whether to recommend that the assistant or the recommended agent perform the one or more actions associated with the image data. The instructions, when executed, further cause the one or more processors to responsive to determining to recommend that the recommended agent perform the one or more actions associated with the image data, cause the recommended agent to at least initiate performance of the one or more actions associated with the image data.

In another example, the disclosure is directed to a computing device that includes a camera, an input device, an output device, one or more processors, and a memory that stores instructions associated with an assistant. The instructions, when executed by the one or more processors cause the one or more processors to receive image data from a camera of the computing device, select, based on the image data and from a plurality of agents accessible from the computing device, a recommended agent to perform one or more actions associated with the image data, and determine whether to recommend that the assistant or the recommended agent perform the one or more actions associated with the image data. The instructions, when executed, further cause the one or more processors to responsive to determining to recommend that the recommended agent perform the one or more actions associated with the image data, cause the recommended agent to at least initiate performance of the one or more actions associated with the image data.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system that executes an example assistant, in accordance with one or more aspects of the present disclosure.

FIG. 2 is a block diagram illustrating an example computing device that is configured to execute an example assistant, in accordance with one or more aspects of the present disclosure.

FIG. 3 is a flowchart illustrating example operations performed by one or more processors executing an example assistant, in accordance with one or more aspects of the present disclosure.

FIG. 4 is a block diagram illustrating an example computing system that is configured to execute an example assistant, in accordance with one or more aspects of the present disclosure.

### DETAILED DESCRIPTION

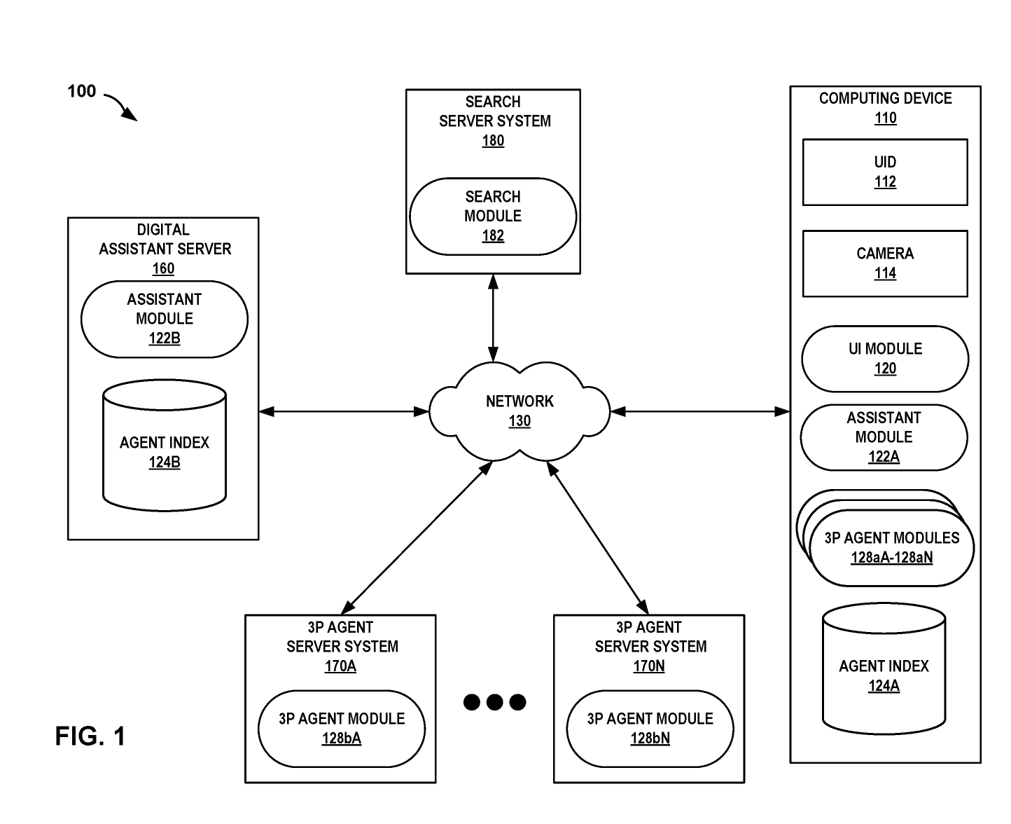

FIG. 1 is a conceptual diagram illustrating an example system that executes an example assistant, in accordance with one or more aspects of the present disclosure. System 100 of FIG. 1 includes digital assistant server 160 in communication, via network 130, with search server system 180, third-party (3P) agent server systems 170A-170N (collectively, “3P agent server systems 170”), and computing device 110. Although system 100 is shown as being distributed amongst digital assistant server 160, 3P agent server systems 170, search server system 180, and computing device 110, in other examples, the features and techniques attributed to system 100 may be performed internally, by local components of computing device 110. Similarly, digital assistant server 160 and/or 3P agent server systems 170 may include certain components and perform various techniques that are otherwise attributed in the below description to search server system 180 and/or computing device 110.

Network 130 represents any public or private communications network, for instance, cellular, Wi-Fi, and/or other types of networks, for transmitting data between computing systems, servers, and computing devices. Digital assistant server 160 may exchange data, via network 130, with computing device 110 to provide a virtual assistance service that is accessible to computing device 110 when computing device 110 is connected to network 130. Similarly, 3P agent server systems 170 may exchange data, via network 130, with computing device 110 to provide virtual agents services that are accessible to computing device 110 when computing device 110 is connected to network 130. Digital assistant server 160 may exchange data, via network 130, with search server system 180 to access a search service provided by search server system 180. Computing device 110 may exchange data, via network 130, with search server system 180 to access the search service provided by search server system 180. 3P agent server systems 170 may exchange data, via network 130, with search server system 180 to access the search service provided by search server system 180.

Network 130 may include one or more network hubs, network switches, network routers, or any other network equipment, that are operatively inter-coupled thereby providing for the exchange of information between server systems 160, 170, and 180 and computing device 110. Computing device 110, digital assistant server 160, 3P agent server systems 170, and search server system 180 may transmit and receive data across network 130 using any suitable communication techniques. Computing device 110, digital assistant server 160, 3P agent server systems 170, and search server system 180 may each be operatively coupled to network 130 using respective network links. The links coupling computing device 110, digital assistant server 160, 3P agent server systems 170, and search server system 180 to network 130 may be Ethernet or other types of network connections and such connections may be wireless and/or wired connections.

Digital assistant server 160, 3P agent server systems 170, and search server system 180 represent any suitable remote computing systems, such as one or more desktop computers, laptop computers, mainframes, servers, cloud computing systems, etc. capable of sending and receiving information both to and from a network, such as network 130. Digital assistant server 160 hosts (or at least provides access to) an assistant service. 3P agent server systems 170 host (or at least provide access to) assistive agents. Search server system 180 hosts (or at least provides access to) a search service. In some examples, digital assistant server 160, 3P agent server systems 170, and search server system 180 represent cloud computing systems that provide access to their respective services via the cloud.

Computing device 110 represents an individual mobile or non-mobile computing device. Examples of computing device 110 include a mobile phone, a tablet computer, a laptop computer, a desktop computer, a server, a mainframe, a set-top box, a television, a wearable device (e.g., a computerized watch, computerized eyewear, computerized gloves, etc.), a home automation device or system (e.g., an intelligent thermostat or security system), a voice-interface or countertop home assistant device, a personal digital assistants (PDA), a gaming system, a media player, an e-book reader, a mobile television platform, an automobile navigation or infotainment system, or any other type of mobile, non-mobile, wearable, and non-wearable computing device configured to execute or access an assistant and receive information via a network, such as network 130

Computing device 110 may communicate with digital assistant server 160, 3P agent server systems 170, and/or search server system 180 via network 130 to access the assistant service provided by digital assistant server 160, the virtual agents provided by 3P agent server systems 170, and/or to access the search service provided by search server system 180. In the course of providing assistant services, digital assistant server 160 may communicate with search server system 180 via network 130 to obtain search results for providing a user of the assistant service information to complete a task. Digital assistant server 160 may communicate with 3P agent server systems 170 via network 130 to engage one or more of the virtual agents provided by 3P agent server systems 170 to provide a user of the assistant service additional assistance. 3P agent server systems 170 may communicate with search server system 180 via network 130 to obtain search results for providing a user of the language agents information to complete a task.

In the example of FIG. 1, computing device 110 includes user interface device (UID) 112, camera 114, user interface (UI) module 120, assistant module 122A, 3P agent modules 128aA-128aN (collectively “agent modules 128a”), and agent index 124A. Digital assistant server 160 includes assistant module 122B and agent index 124B. Search server system 180 includes search module 182. 3P agent server systems 170 each include a respective 3P agent module 128bA-128bN (collectively “agent modules 128b”).

UIC 112 of computing device 110 may function as an input and/or output device for computing device 110. UID 112 may be implemented using various technologies. For instance, UID 112 may function as an input device using presence-sensitive input screens, microphone technologies, infrared sensor technologies, cameras, or other input device technology for use in receiving user input. UID 112 may function as output device configured to present output to a user using any one or more display devices, speaker technologies, haptic feedback technologies, or other output device technology for use in outputting information to a user.

Camera 114 of computing device 110 may be an instrument for recording or capturing images. Camera 114 may capture individual still photographs or sequences of images constituting videos or movies. Camera 114 may be a physical component of computing device 110. Camera 114 may include a camera application that acts as an interface between a user of computing device 110 or an application executing at computing device 110 (and the functionality of camera 114. Camera 114 may perform various functions, such as capturing one or more images, focusing on one or more objects, and utilizing various flash settings, among other things.

Modules 120, 122A, 122B, 128a, 128b, and 182 may perform operations described using software, hardware, firmware, or a mixture of hardware, software, and firmware residing in and/or executing at one of computing device 110, digital assistant server 160, search server system 180, and 3P agent server systems 170. Computing device 110, digital assistant server 160, search server system 180, and 3P agent server systems 170 may execute modules 120, 122A, 122B, 128a, 128b, and 182 with multiple processors or multiple devices. Computing device 110, digital assistant server 160, search server system 180, and 3P agent server systems 170 may execute modules 120, 122A, 122B, 128a, 128b, and 182 as virtual machines executing on underlying hardware. Modules 120, 122A, 122B, 128a, 128b, and 182 may execute as one or more services of an operating system or at an application layer of a computing platform of computing device 110, digital assistant server 160, 3P agent server systems 170, or search server system 180.

UI module 120 may manage user interactions with UID 112, inputs detected by camera 114, and interactions between UID 112, camera 114, and other components of computing device 110. UI module 120 may interact with digital assistant server 160 so as to provide assistant services via UID 112. UI module 120 may cause UID 112 to output a user interface as a user of computing device 110 views output and/or provides input at UID 112.

After receiving explicit and unambiguous permission from a user to make use of, store, and/or analyze personal information of the user, UI module 120, UID 112, and camera 114 may receive one or more indications of input (e.g., voice input, touch input, non-touch or presence-sensitive input, video input, audio input, etc.) from a user as the user interacts with computing device 110, at different times and when the user and computing device 110 are at different locations. UI module 120, UID 112, and camera 114 may interpret inputs detected at UID 112 and camera 114 and may relay information about the inputs detected at UID 112 and camera 114 to assistant modules 122 and/or one or more other associated platforms, operating systems, applications, and/or services executing at computing device 110, for example, to cause computing device 110 to perform functions.

Even after providing permission, a user may revoke permission by providing input to computing device 110. In response, computing device 110 will cease making use of, and will delete, the personal permission of the user.

UI module 120 may receive information and instructions from one or more associated platforms, operating systems, applications, and/or services executing at computing device 110 and/or one or more remote computing systems, such as server systems 160 and 180. In addition, UI module 120 may act as an intermediary between the one or more associated platforms, operating systems, applications, and/or services executing at computing device 110, and various output devices of computing device 110 (e.g., speakers, LED indicators, audio or haptic output device, etc.) to produce output (e.g., a graphic, a flash of light, a sound, a haptic response, etc.) with computing device 110. For example, UI module 120 may cause UID 112 to output a user interface based on data UI module 120 receives via network 130 from digital assistant server 160. UI module 120 may receive, as input from digital assistant server 160 and/or assistant module 122, information (e.g., audio data, text data, image data, etc.) and instructions for presenting the user interface.

Search module 182 may execute a search for information determined to be relevant to a search query that search module 182 automatically generates (e.g., based on contextual information associated with computing device 110) or that search module 182 receives from digital assistant server 160, 3P agent server systems 170, or computing device 110 (e.g., as part of a task that an assistant is completing on behalf of a user of computing device 110). Search module 182 may conduct an Internet search or local device search based on a search query to identify information related to the search query. After executing a search, search module 182 may output the information returned from the search (e.g., the search results) to digital assistant server 160, one or more of 3P agent server systems 170, or computing device 110.

Search module 182 may execute image based searches to determine one or more visual entities contained in an image. For example, search module 182 may receive as input (e.g., from assistant modules 122) image data, and in response, output one or more labels or other indications of the entities (e.g., objects) that are recognizable from the image. For instance, search module 182 may receive an image of a wine bottle as input and output labels or other identifiers of the visual entities: wine bottle, the brand of wine, a type of wine, a type of bottle, etc. As another example, search module 182 may receive an image of a dog in a street as input and output labels or other identifiers of the visual entities recognizable in the street view, such as: dog, street, passing by, dog in foreground, Boston terrier, etc. Accordingly, search module 182 may output information or entities indicative of one or more relevant objects or entities associated with the image data (e.g., an image or video stream), from which assistant module 122A and 122B can infer “intents” associated with the image data so as to determine one or more potential actions.

Assistant module 122A of computing device 110 and assistant module 122B of digital assistant server 160 may each perform similar functions described herein for automatically executing an assistant that is configured to select agents to: a) satisfy user input (e.g., spoken utterances, textual input, etc.) received from a user of a computing device and/or b) perform actions inferred from image data captured by a camera such as camera 114. Assistant module 122B and assistant module 122A may be referred to collectively as assistant modules 122. Assistant module 122B may maintain agent index 124B as part of an assistant service that digital assistant server 160 provides via network 130 (e.g., to computing device 110). Assistant module 122A may maintain agent index 124A as part of an assistant service that executes locally at computing device 110. Agent index 124A and agent index 124B may be referred to collectively as agent indices 124. Assistant module 122B and agent index 124B represent server-side or cloud implementations of an example assistant whereas assistant module 122A and agent index 124A represent a client-side or local implementation of the example assistant.

Modules 122A and 122B may each include respective software agents configured to execute as intelligent personal assistants that can perform tasks or services for an individual, such as a user of computing device 110. Modules 122A and 122B may perform these tasks or services based on user input (e.g., detected at UID 112), image data (e.g., captured by camera 114), context awareness (e.g., based on location, time, weather, history, etc.), and/or the ability to access other information (e.g., weather or traffic conditions, news, stock prices, sports scores, user schedules, transportation schedules, retail prices, etc.) from a variety of other information sources (e.g., either stored locally at computing device 110, digital assistant server 160, obtained via the search service provided by search server system 180, or obtained via some other information source via network 130).

Modules 122A and 122B may perform artificial intelligence and/or machine learning techniques on the inputs received from the variety of information sources to automatically identify and complete one or more tasks on behalf of a user. For example, given image data captured by camera 114, assistant module 122A may rely on a neural network to determine, from the image data, a task a user may wish to perform and/or one or more agents for performing the task.

In some examples, the assistants provided by modules 122 are referred to as first-party (1P) assistants and/or 1P agents. For instance, the agents represented by modules 122 may share a common publisher and/or a common developer with an operating system of computing device 110 and/or an owner of digital assistant server 160. As such, in some examples, the agents represented by modules 122 may have abilities not available to other agents, such as third-party (3P) agents. In some examples, the agents represented by modules 122 may not both be 1P agents. For instance, the agent represented by assistant module 122A may be a 1P agent whereas the agent represented by assistant module 122B may be a 3P agent.

As discussed above, assistant module 122A may represent a software agent configured to execute as an intelligent personal assistant that can perform tasks or services for an individual, such as a user of computing device 110. However, in some examples, it may be desirable that the assistant utilize other agents to perform tasks or services for the individual.

3P agent modules 128b and 128a (collectively, “3P agent modules 128”) represent other assistants or agents of system 100 that may be utilized by assistant modules 122 to perform tasks or services for the individual. The assistants and/or agents provided by modules 128 be referred to as third-party (3P) assistants and/or 3P agents. The assistants and/or agents represented by 3P agent modules 128 may not share a common publisher with an operating system of computing device 110 and/or an owner of digital assistant server 160. As such, in some examples, the assistants and/or agents represented by modules 128 may not have abilities or access to data that are available to other assistants and/or agents, such as 1P agent assistants and/or agents. Said differently, each agent module 128 may be a 3P agent associated with a respective third-party service that is accessible from computing device 110, and in some examples, the respective third-party service associated with each agent module 128 may be different from services provided by assistant modules 122. 3P agent modules 128b represent server-side or cloud implementations of example 3P agents whereas 3P agent modules 128a represent client-side or local implementations of the example 3P agents.

3P agent modules 128 may automatically execute respective agents that are configured to satisfy utterances received from a user of a computing device, such as computing device 110, or perform a task or action based at least in part on image data obtained by a computing device, such as computing device 110. One or more of 3P agent modules 128 may represent software agents configured to execute as intelligent personal assistants that can perform tasks or services for an individual, such as a user of computing device 110 whereas one or more other 3P agent modules 128 may represent software agents that may be utilized by assistant modules 122 to perform tasks or services for assistant modules 122.

One or more components of system 100, such as assistant module 122A and/or assistant module 122B, may maintain agent index 124A and/or agent index 124B (collectively, “agent indices 124”) to store, in a semi-structured index, agent information related to agents that are available to an individual, such as a user of computing device 110, or available to an assistant, such as assistant modules 122, executing at or accessible to computing device 110. For instance, agent indices 124 may contain a single entry with agent information for each available agent.

An entry included in agent indices 124 for a particular agent may be constructed from agent information provided by a developer of the particular agent. Some example information fields that may be included in such an entry, or which may be used to construct the entry, include but are not limited to: a description of the agent, one or more entry points of the agent, a category of the agent, one or more triggering phrases of the agent, a website associated with the agent, a list of the agent's capabilities, and/or one or more graphical intents (e.g., identifiers of entities contained in images or image portions that may be acted on by the agent). In some examples, one or more of the information fields may be written in free-form natural language. In some examples, one or more of the information fields may be selected from a pre-defined list. For instance, the category field may be selected from a pre-defined set of categories (e.g., games, productivity, communication). In some examples, an entry point of an agent may be a device type(s) used to interface with the agent (e.g., cell phone). In some examples, an entry point of an agent may be a resource address or other argument of the agent.

In some examples, agent indices 124 may store agent information related to the use and/or the performance of the available agents. For instance, agent indices 124 may include an agent-quality score for each available agent. In some examples, the agent-quality scores may be determined based on one or more of: whether a particular agent is selected more often than competing agents, whether the agent's developer has produced other high quality agents, whether the agent's developer has good (or bad) spam scores on other user properties, and whether users typically abandon the agent in the middle of execution. In some examples, the agent-quality scores may be represented as a value between 0 and 1, inclusive.

Agent indices 124 may provide a mapping between graphical intents and agents. As discussed above, a developer of a particular agent may provide one or more graphical intents to be associated with the particular agent. Examples of graphical intents include mathematical operators or formulas, logos, icons, trademarks, human for animal faces or features, buildings, landmarks, signage, symbols, objects, entities, concepts, or any other thing that may be recognizable from image data. In some examples, to improve the quality of agent selection, assistant modules 122 may expand upon the provided graphical intents. For instance, assistant modules 122 may expand a graphical intent by associating the graphical intent with other similar or related graphical intents. For example, assistant modules 122 may expand upon a graphical intent for a dog with more specific dog related intents (e.g., breeds, colors, etc.) or more general dog related intents (e.g., other pets, other animals, etc.).

In operation, assistant module 122A may receive, from UI module 120, image data obtained by camera 114. As one example, assistant module 122A may receive image data that indicates one or more visual entities in the field of view of camera 114. For example, while sitting down in a restaurant, a user may point camera 114 of computing device 110 towards a wine bottle on the table and provide user input to UID 112 that causes camera 114 to take a picture of the wine bottle. The image data may be captured in the context of a separate application, such as a camera application, messaging application, etc. and access to the image provided to assistant module 122A or alternatively from with the context of an assistant application operating aspects of assistant module 122A.

In accordance with one or more techniques of this disclosure, assistant module 122A may select a recommended agent module 128 to perform one or more actions associated with image data. For instance, assistant module 122A may determine whether a 1P agent (i.e., a 1P agent provided by assistant module 122A), a 3P agent (i.e., a 3P agent provided by one of 3P agent modules 128), or some combination of 1P agents and 3P agents may perform an action or assist the user in performing a task related to the image data of the wine bottle.

Assistant module 122A may base the agent selection on an analysis of the image data. As one example, assistant module 122A may perform visual recognition techniques on the image data to determine all the possible entities, objects and concepts that could be associated with the image data. For example, assistant module 122A may output the image data via network 130 to search server system 180 with a request for search module 182 to perform visual recognition techniques on the image data to by performing an image based search of the image data. In response to the request, assistant module 122A may receive, via network 130, a list of intents returned from the image based search performed by search module 182. The list of intents returned from the image based search of the image of the wine bottle may return an intent related to “wine bottles” or “wine” in general.

Assistant module 122A may determine, based on entries in agent index 124A, whether any agents (e.g., 1P or 3P agents) have registered with the intent(s) inferred from the image data. For example, assistant module 122A may input the wine intent into agent index 124A and receive as output a list of one or more agent modules 128 that have registered with wine intents and therefore may be used to perform actions associated with wine.

Assistant module 122A may rank the one or more agents that have registered with an intent and select one or more highest ranking agents as the recommended agent to perform actions associated with the image data. For example, assistant module 122A may determine the ranking based on agent-quality scores associated with each agent module 128 that has registered with an intent. Assistant module 122A may rank agents based on popularity or frequency of use; that is, how often a user of computing device 110 or users of other computing devices use a particular agent module 128. Assistant module 122A may rank agent modules 128 based on context (e.g., location, time, and other contextual information) to select a recommended agent module 128 from all the agents that have registered with an identified intent.

Assistant module 122A may develop rules for predicting a preferred agent module 128 to recommend for a given context, for a particular user, and/or for a particular intent. For example, based on past user interaction data obtained from the user of computing device 110 and users of other computing devices, assistant module 122A may determine that while most users prefer to use a particular agent module 128 for performing actions based on a particular intent, the user of computing device 110 may instead prefer to use a different agent module 128 for performing actions based on the particular intent and therefore rank the preferred agent of the user higher than the agent most other users prefer.

Assistant module 122A may determine whether to recommend that assistant module 122A or the recommended agent module 128 perform the one or more actions associated with the image data. For example, in some cases, assistant module 122A may be a recommended agent for performing an action based at least in part on image data whereas one of agent modules 128 may be the recommended agent. Assistant module 122A may rank assistant module 122A in amongst the one or more agent modules 128 and select either the highest-ranking agent (e.g., either assistant module 122A or agent module 128) perform an action based on an inferred intent from image data received from camera 114. For example, agent module 128aA may be an agent configured to provide information about various wines and may also provide access to a commerce service from which wines may be purchased. Assistant module 122A may determine that agent module 128aA is a recommended agent form performing an action related to wine.

Responsive to determining to recommend that the recommended agent perform the one or more actions associated with the image data, assistant module 122A may output an indication of the recommended agent. For example, assistant module 122A may cause UI module 120 to output an audible, visual, and/or haptic notification via UID 112 indicating that, based at least in part on image data captured by camera 114, assistant module 122A is recommending the user interact with agent module 128aA to help the user perform an action at a current time. The notification may include an indication that assistant module 122A has inferred from the image data the user may be interested in wine or wines and may inform the user that agent module 128aA can help answer questions or even order wine.

In some examples, the recommended agent may be more than one recommended agent. In such a case, assistant module 122A may output as part of the notification, a request for the user to choose a particular recommended agent.

Assistant module 122A may receive user input confirming the recommended agent. For example, after outputting the notification, the user may provide touch input at UID 112 or voice input to UID 112 confirming that the user wishes to use the recommended agent to perform an action on the image data obtained by camera 114.

Unless assistant module 122A receives such user confirmation, or other explicit consent, assistant module 122A may refrain from outputting any image data captured by camera 114 to any of modules 122A. To be clear, assistant modules 122 may refrain from making use of, or analyzing any personal information of a user or computing device 110, including image data capture by camera 114, unless assistant modules 122 receive explicit consent from the user to do so. Assistant modules 122 may also provide an opportunity for the user to withdraw or remove consent.

In any case, responsive to receiving the user input confirming the recommended agent, assistant module 122A may cause the recommended agent to at least initiate performance of the one or more actions associated with the image data. For example, assistant module 122A receives information confirming the user wishes to use the recommended agent to perform an action on the image data obtained by camera 114, assistant module 122A may send the image data captured by camera 114 to the recommended agent with instructions to process the image data and take any appropriate actions. For instance, assistant module 122A may send the image data captured by camera 114 to agent module 128aA. Agent module 128aA may perform its own analysis on the image data, open a website, trigger an action, start a conversation with the user, show a video, or perform any other related action using the image data. For instance, agent module 128aA may perform its own image analysis on the image data of the wine bottle, determine a specific brand or type of wine, and output a notification via UI module 120 and UID 112 asking the user if he or she wants to buy bottle or see reviews.

In this way, an assistant in accordance with the techniques of this disclosure may be configured to not only determine actions that may be appropriate for a user's environment or related to graphical “intents”, but may also be configured to recommend an appropriate actor or agent for performing the actions. Accordingly, the described techniques may improve usability with an assistant by reducing the quantity of user inputs required for a user to discover actions that may be performed in the user's environment, and may also cause the assistant to perform, various actions with far fewer inputs.

Among the several benefits provided by the aforementioned approach are: (1) the processing complexity and time for a device to act may be reduced by proactively directing the user to actions or capabilities of the assistant rather than relying on specific inquiries from the user or for the user to spend time learning the actions or capabilities via documentation or other ways; (2) meaningful information and information associated with the user may be stored locally reducing the need for complex and memory-consuming transmission security protocols on the user's device for the private data; (3) because the example assistant directs the user to actions or capabilities, fewer specific inquiries may be requested by the user, thereby reducing demands on a user device for query rewriting and other computationally complex data retrieval; and (4) network usage may be reduced as the data that the assistant module needs to respond to specific inquiries may be reduced as a quantity of specific inquires is reduced.

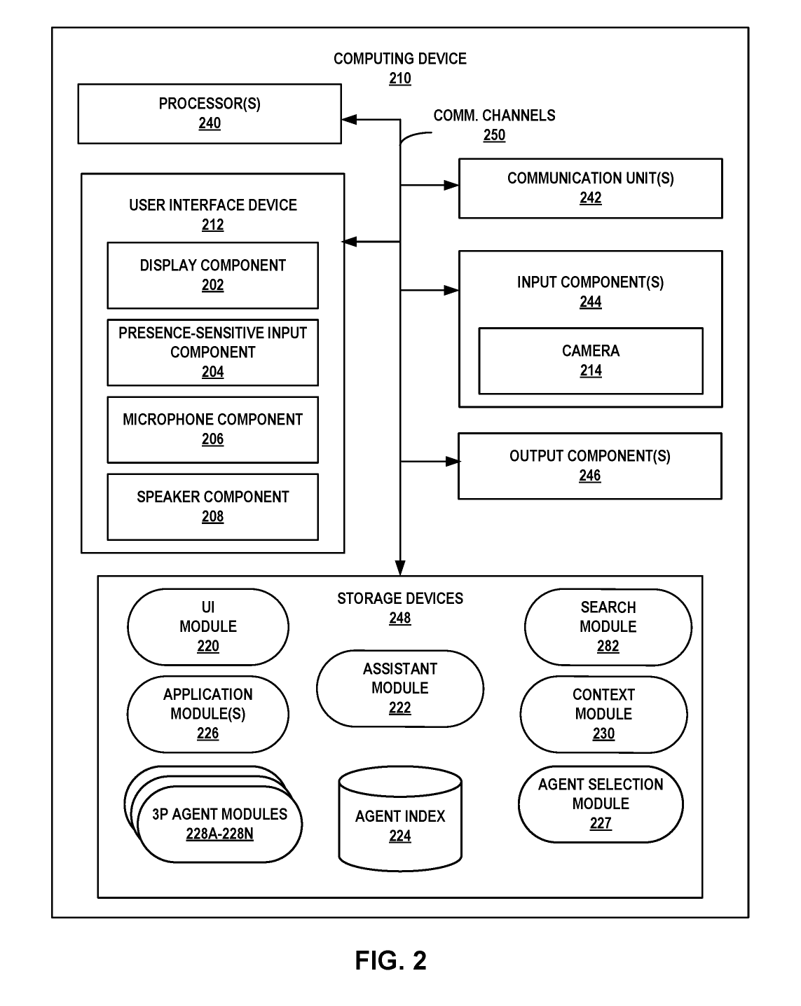

FIG. 2 is a block diagram illustrating an example computing device that is configured to execute an example assistant, in accordance with one or more aspects of the present disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes user interface device (USD) 212, one or more processors 240, one or more communication units 242, one or more input components 244 including camera 214, one or more output components 246, and one or more storage components 248. USD 212 includes display component 202, presence-sensitive input component 204, microphone component 206, and speaker component 208. Storage components 248 of computing device 210 include UI module 220, assistant module 222, search module 282, one or more application modules 226, agent selection module 227, 3P agent module 228A-228N (collectively “3P agent modules 228”), context module 230, and agent index 224.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices (e.g., digital assistant server 160 and/or search server system 180 of system 100 of FIG. 1) via one or more wired and/or wireless networks by transmitting and/or receiving network signals on one or more networks (e.g., network 130 of system 100 of FIG. 1). Examples of communication units 242 include a network interface card (e.g. such as an Ethernet card), an optical transceiver, a radio frequency transceiver, a global positioning system (GPS) receiver, or any other type of device that can send and/or receive information. Other examples of communication units 242 may include short wave radios, cellular data radios, wireless network radios, as well as universal serial bus (USB) controllers.

One or more input components 244 of computing device 210, including camera 214, may receive input. Examples of input are tactile, text, audio, image, and video input. In addition to camera 114, input components 242 of computing device 210, in one example, includes a presence-sensitive input device (e.g., a touch sensitive screen, a PSD), mouse, keyboard, voice responsive system, microphone or any other type of device for detecting input of computing device 210′s environment or input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 246 of computing device 110 may generate output. Examples of output are tactile, audio, and video output. Output components 246 of computing device 210, in one example, includes a presence-sensitive display, sound card, video graphics adapter card, speaker, cathode ray tube (CRT) monitor, liquid crystal display (LCD), or any other type of device for generating output to a human or machine.

UID 212 of computing device 210 may be similar to UID 112 of computing device 110 and includes display component 202, presence-sensitive input component 204, microphone component 206, and speaker component 208. Display component 202 may be a screen at which information is displayed by USD 212 while presence-sensitive input component 204 may detect an object at and/or near display component 202. Speaker component 208 may be a speaker from which audible information is played by UID 212 while microphone component 206 may detect audible input provided at and/or near display component 202 and/or speaker component 208.

While illustrated as an internal component of computing device 210, UID 212 may also represent an external component that shares a data path with computing device 210 for transmitting and/or receiving input and output. For instance, in one example, UID 212 represents a built-in component of computing device 210 located within and physically connected to the external packaging of computing device 210 (e.g., a screen on a mobile phone). In another example, UID 212 represents an external component of computing device 210 located outside and physically separated from the packaging or housing of computing device 210 (e.g., a monitor, a projector, etc. that shares a wired and/or wireless data path with computing device 210).

As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface.

Speaker component 208 may comprise a speaker built-in to a housing of computing device 210 and in some examples, may be a speaker built-in to a set of wired or wireless headphones that are operably coupled to computing device 210. Microphone component 206 may detect audible input occurring at or near UID 212. Microphone component 206 may perform various noise cancellation techniques to remove background noise and isolate user speech from a detected audio signal.

UID 212 of computing device 210 may detect two-dimensional and/or three-dimensional gestures as input from a user of computing device 210. For instance, a sensor of UID 212 may detect a user's movement (e.g., moving a hand, an arm, a pen, a stylus, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 226, 227, 228, 230, and 282 may be operable by processors 240 to perform various actions, operations, or functions of computing device 210. For example, processors 240 of computing device 210 may retrieve and execute instructions stored by storage components 248 that cause processors 240 to perform the operations modules 220, 222, 226, 227, 228, 230, and 282. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 226, 227, 228, 230, and 282 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 226, 227, 228, 230, and 282 and agent index 224. Storage components 248 may include a memory configured to store data or other information associated with modules 220, 222, 226, 227, 228, 230, and 282 and agent index 224.

UI module 220 may include all functionality of UI module 120 of computing device 110 of FIG. 1 and may perform similar operations as UI module 120 for managing a user interface that computing device 210 provides at USD 212 for example, for facilitating interactions between a user of computing device 110 and assistant module 222. For example, UI module 220 of computing device 210 may receive information from assistant module 222 that includes instructions for outputting (e.g., displaying or playing audio) an assistant user interface. UI module 220 may receive the information from assistant module 222 over communication channels 250 and use the data to generate a user interface. UI module 220 may transmit a display or audible output command and associated data over communication channels 250 to cause UID 212 to present the user interface at UID 212.

UI module 220 may receive an indication of one or more inputs detected by camera 114 and may output information about the camera inputs to assistant module 222. In some examples, UI module 220 may receive an indication of one or more user inputs detected at UID 212 and may output information about the user inputs to assistant module 222. For example, UID 212 may detect a voice input from a user and send data about the voice input to UI module 220.

UI module 220 may send an indication of a camera input to assistant module 222 for further interpretation. Assistant module 222 may determine, based on the camera input, that the detected camera input may be associated with one or more user tasks.

Application modules 226 represent the various individual applications and services executing at and accessible from computing device 210 that may be accessed by an assistant, such as assistant module 222, to provide user with information and/or perform a task. A user of computing device 210 may interact with a user interface associated with one or more application modules 226 to cause computing device 210 to perform a function. Numerous examples of application modules 226 may exist and include, a fitness application, a calendar application, a search application, a map or navigation application, a transportation service application (e.g., a bus or train tracking application), a social media application, a game application, an e-mail application, a chat or messaging application, an Internet browser application, or any and all other applications that may execute at computing device 210.

Search module 282 of computing device 210 may perform integrated search functions on behalf of computing device 210. Search module 282 may be invoked by UI module 220, one or more of application modules 226, and/or assistant module 222 to perform search operations on their behalf. When invoked, search module 282 may perform search functions, such as generating search queries and executing searches based on generated search queries across various local and remote information sources. Search module 282 may provide results of executed searches to the invoking component or module. That is, search module 282 may output search results to UI module 220, assistant module 222, and/or application modules 226 in response to an invoking command.

Context module 230 may collect contextual information associated with computing device 210 to define a context of computing device 210. Specifically, context module 210 is primarily used by assistant module 222 to define a context of computing device 210 that specifies the characteristics of the physical and/or virtual environment of computing device 210 and a user of computing device 210 at a particular time.

As used throughout the disclosure, the term “contextual information” is used to describe any information that can be used by context module 230 to define the virtual and/or physical environmental characteristics that a computing device, and the user of the computing device, may experience at a particular time. Examples of contextual information are numerous and may include: sensor information obtained by sensors (e.g., position sensors, accelerometers, gyros, barometers, ambient light sensors, proximity sensors, microphones, and any other sensor) of computing device 210, communication information (e.g., text based communications, audible communications, video communications, etc.) sent and received by communication modules of computing device 210, and application usage information associated with applications executing at computing device 210 (e.g., application data associated with applications, Internet search histories, text communications, voice and video communications, calendar information, social media posts and related information, etc.). Further examples of contextual information include signals and information obtained from transmitting devices that are external to computing device 210. For example, context module 230 may receive, via a radio or communication unit of computing device 210, beacon information transmitted from external beacons located at or near a physical location of a merchant.

Assistant module 222 may include all functionality of assistant module 122A of computing device 110 of FIG. 1 and may perform similar operations as assistant module 122A for providing an assistant. In some examples, assistant module 222 may execute locally (e.g., at processors 240) to provide assistant functions. In some examples, assistant module 222 may act as an interface to a remote assistance service accessible to computing device 210. For example, assistant module 222 may be an interface or application programming interface (API) to assistance module 122B of digital assistant server 160 of FIG. 1.

Agent selection module 227 may include functionality to select one or more agents to satisfy a given utterance. In some examples, agent selection module 227 may be a standalone module. In some examples, agent selection module 227 may be included in assistant module 222.

Similar to agent indices 124A and 124B of system 100 of FIG. 1, agent index 224 may store information related to agents, such as 3P agents. Assistant module 222 and/or agent selection module 227 may rely on the information stored at agent index 224, in addition to any information provided by context module 230 and/or search module 282, to perform assistant tasks and/or select agents for performing a task or operation inferred from image data.

At the request of assistant module 222, agent selection module 227 may select one or more agents to perform a task or operation associated with image data captured by camera 214. However, prior to selecting a recommended agent to perform one or more actions associated with the image data, agent selection module 227 may undergo a pre-configuration or setup process to generate agent index 224 and/or to receive information from 3P agent modules 228 about their capabilities.

Agent selection module 227 may receive, from each particular agent from the plurality of agents, a registration request that includes one or more respective intents associated with that particular agent. Agent selection module 227 may register each particular agent from the plurality of agents with the one or more respective intents associated that particular agent. For example, when loaded onto computing device 220, 3P agent modules 228 may send information to agent selection module 227 that registers each agent with agent selection module 227. The registration information may include an agent identifier and one or more intents that the agent can satisfy. For example, 3P agent module 228A may be a pizza ordering agent for PizzaHouse Company and when installed on computing device 220, 3P agent module 228A may send information to agent selection module 227 that registers 3P agent module 228A with intents associated with the name “PizzaHouse”, the PizzaHouse logo or trademark, and images or words indicative of “food”, “restaurant”, and “pizza”. Agent selection module 227 may store the registration information at agent index 224 along with an identifier of 3P agent module 228A.

The agent information stored at agent index 224 from which agent selection module 227 ranks identified agents includes: a popularity score of the particular agent indicating a frequency of use of the particular agent by the user of computing device 210 and/or users of other computing devices, a relevancy score between the intents of the particular agent and the image data, a usefulness score between the particular agent and the image data, an importance score associated with each of the one or more intents that are associated with the particular agent, a user satisfaction score associated with the particular agent, a user interaction score associated with the particular agent, and a quality score associated with the particular agent (e.g., a weighted sum of the matches between the various intents inferred from the image data and the intents registers with an agent). A ranking of an agent module 328 may be based on a combined score for each possible agent as determined by agent selection module 227, for instance, by multiplying or adding two different types of scores.

Based on agent index 224 and/or the registration information received from 3P agent modules 228 about their capabilities, agent selection module 227 may select a recommended agent responsive to determining that the recommended agent is registered with one or more intents inferred from the image data. For example, agent selection module 227 may use image data from assistant module 222 that is determined, by agent selection module 227, to be indicative of an intent to order food, pizza, etc. Agent selection module 227 may input the intent inferred from the image data into agent index 224 and receive as output from agent index 224, an indication of 3P agent module 228A and possibly one or more other 3P agent modules 228 that have registered with food or pizza intents.

Agent selection module 227 may identify registered agents from agent index 224 that match one or more intents inferred from image data. Agent selection module 227 may rank the identified agents. In other words, in response to inferring one or more intents from the image data: agent selection module 227 may identify, from 3P agent modules 228, one or more 3P agent modules 228 that are registered with at least one of the one or more intents that has been inferred from image data. Based on information related to each of the one or more 3P agent modules 228 and the one or more intents, agent module 227 may determine a ranking of the one or more 3P agent modules 228 and select, based at least in part on the ranking, from the one or more 3P agent modules 228, the recommended 3P agent module 228.

In some examples, agent selection module 227 may identify one or more recommended agents based at least in part on image data by sending the image data through an image based internet search (i.e., cause search module 282 to search the internet based on the image data). In some examples, agent selection module 227 may identify one or more recommended agents based at least in part on image data by sending the image data through an image based internet search in addition to consulting agent index 224.

In some examples, agent index 224 may include or be implemented as a machine learning system to generate scores for agents related to intents. For example, agent selection module 227 may input, into a machine learning system of agent index 224, one or more intents inferred from image data. The machine learning system may determine, based on information related to each of the one or more agents and the one or more intents, a respective score for each of the one or more agents. Agent selection module 227 may receive, from the machine learning system, the respective score for each of the one or more agents.

In some examples, agent index 224 and/or a machine learning system of agent index 224 may rely on information related to assistant module 222 and whether assistant module 222 is registered with any intents to determine if to recommend assistant module 222 perform one or more actions or tasks based at least in part on image data. That is, agent selection module 227 may input, into a machine learning system of agent index 224, one or more intents inferred from image data. In some examples, agent selection module 227 may input contextual information obtained by context module 230 into the machine learning system of agent index 224 to determine the ranking of 3P agent modules 228. The machine learning system may determine, based on information related to assistant module 222, the one or more intents, and/or the contextual information, a respective score for assistant module 222. Agent selection module 227 may receive, from the machine learning system, the respective score for assistant module 222.

Agent selection module 227 may determine whether to recommend that assistant module 222 or the recommended agent from 3P agent modules 228 perform the one or more actions associated with the image data. For example, agent selection module 227 may determine whether the respective score for a highest ranking one of 3P agent modules 228 exceeds the score of assistant module 222. Responsive to determining that the respective score for the highest ranking agent from 3P agent modules 228 exceeds the score of assistant module 222, agent selection module 227 may determine to recommend that the highest ranking agent perform the one or more actions associated with the image data. Responsive to determining that the respective score for the highest-ranking agent from 3P agent modules 228 does not exceed the score of assistant module 222, agent selection module 227 may determine to recommend that the highest-ranking agent perform the one or more actions associated with the image data.

Agent selection module 227 may analyze the rankings and/or the results from the internet search to select an agent to perform one or more actions. For instance, agent selection module 227 may inspect search results to determine whether there are web page results associated with agents. If there are web page results associated with agents, agent selection module 227 may, insert the agents associated with the web page results into the ranked results (if said agents are not already included in the ranked results). Agent selection module 227 may boost or decrease agent's rankings according to the strength of the web score. In some examples, agent selection module 227 may query a personal history store to determine whether the user has interacted with any of the agents in the result set. If so, agent selection module 227 may we those agents a boost (i.e., increased ranking) depending on how often the strength of the user's history with them.

Agent selection module 227 may select a 3P agent to recommend to perform an action inferred from image data based on a ranking. For instance, agent selection module 227 may select a 3P agent with the highest ranking. In some examples, such as where there is a tie in the rankings and/or if the ranking of the 3P agent with the highest ranking is less than a ranking threshold, agent selection module 227 may solicit user input to select a 3P agent to satisfy the utterance. For instance, agent selection module 227 may cause UI module 220 to output a user interface (i.e., a selection UI) requesting that the user select a 3P agent from N (e.g., 2, 3, 4, 5, etc.) moderately ranked 3P agents to satisfy the utterance. In some examples, the N moderately ranked 3P agents may include the top N ranked agents. In some examples, the N moderately ranked 3P agents may include agents other than the top N ranked agents.

Agent selection module 227 may examine attributes of the agents and/or obtain results from various 3P agents, rank those results, then cause assistant module 222 to invoke (i.e., select) the 3P agent providing the highest ranked result. For instance, if an intent is related to “pizza”, agent selection module 227 may determine the user's current location, determine which source of pizza is closest to the user's current location, and rank the pizza source associated with that current location highest. Similarly, agent selection module 227 may poll multiple 3P agents on price of an item, then provide the agent to permit the user to complete the purchase based on the lowest price. Agent selection module 227 may determine that no 1P agent can fulfill the task before determining whether any 3P agents can, and assuming only one or a few of them can, provide only those agents as options to the user for implementing the task.

In this way, computing device 210, via an assistant module 222 and agent selection module 227, may provide an assistant service that is less complex then other types of digital assistant services. That is, computing device 210 may rely on other service providers or 3P agents to perform at least some complex tasks rather than trying to handle all possible tasks that could come up during everyday use. In doing so, computing device 210 may preserve private relationships a user already has in place with 3P agents.

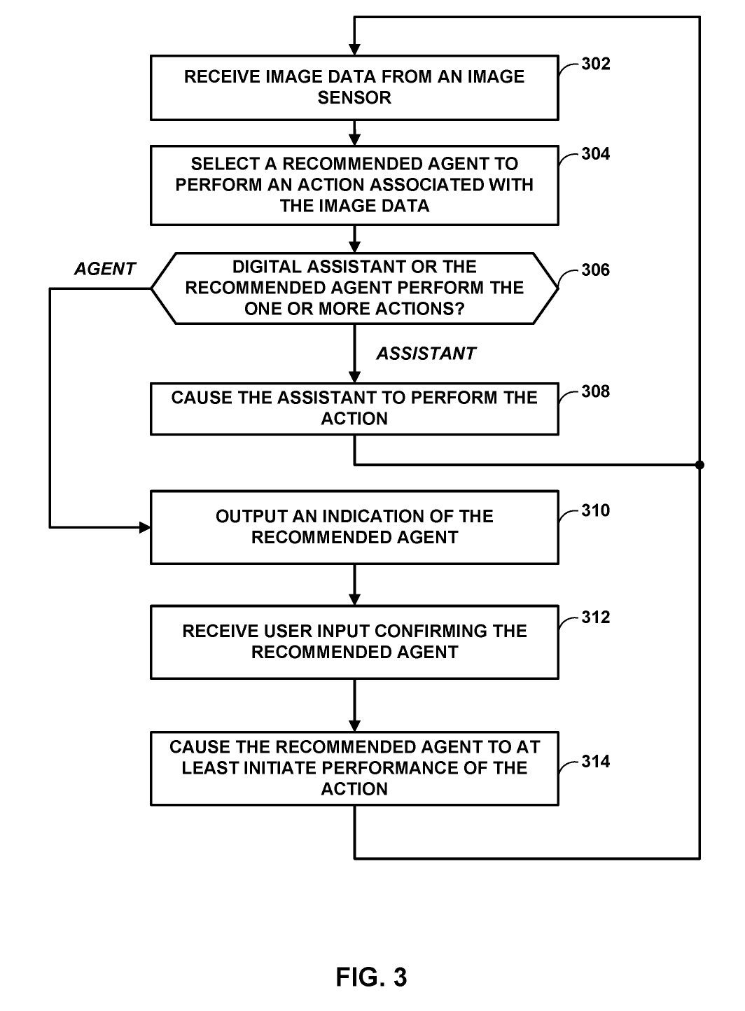

FIG. 3 is a flowchart illustrating example operations performed by one or more processors executing an example assistant, in accordance with one or more aspects of the present disclosure. FIG. 3 is described below in the context of computing device 110 of system 100 of FIG. 1. For example, assistant module 122A while executing at one or more processors of computing device 110 may perform operations 302-314, in accordance with one or more aspects of the present disclosure. And in some examples, assistant module 122B while executing at one or more processors of digital assistant server 160 may perform operations 302-314, in accordance with one or more aspects of the present disclosure.

In operation, computing device 110 may receive image data such as from camera 114 or other image sensor (302). For example, after receiving explicit permission from a user to make use of personal information, including image data, a user of computing device 110 may point camera 114 of computing device 110 towards a movie poster on a wall and provide user input to UID 112 that causes camera 114 to take a picture of the movie poster.

In accordance with one or more techniques of this disclosure, assistant module 122A may select a recommended agent module 128 to perform one or more actions associated with image data (304). For instance, assistant module 122A may determine whether a 1P agent (i.e., a 1P agent provided by assistant module 122A), a 3P agent (i.e., a 3P agent provided by one of 3P agent modules 128), or some combination of 1P agents and 3P agents may perform an action or assist the user in performing a task related to the image data of the movie poster.

Assistant module 122A may base the agent selection on an analysis of the image data. As one example, assistant module 122A may perform visual recognition techniques on the image data to determine all the possible entities, objects and concepts that could be associated with the image data. For example, assistant module 122A may output the image data via network 130 to search server system 180 with a request for search module 182 to perform visual recognition techniques on the image data to by performing an image based search of the image data. In response to the request, assistant module 122A may receive, via network 130, a list of intents returned from the image based search performed by search module 182. The list of intents returned from the image based search of the image of the wine bottle may return an intent related to “the name of the movie” or “movie” or “movie posters” in general.

Assistant module 122A may determine, based on entries in agent index 124A, whether any agents (e.g., 1P or 3P agents) have registered with the intent(s) inferred from the image data. For example, assistant module 122A may input the movie intent into agent index 124A and receive as output a list of one or more agent modules 128 that have registered with movie intents and therefore may be used to perform actions associated with movies.

Assistant module 122A may develop rules for predicting a preferred agent module 128 to recommend for a given context, for a particular user, and/or for a particular intent. For example, based on past user interaction data obtained from the user of computing device 110 and users of other computing devices, assistant module 122A may determine that while most users prefer to use a particular agent module 128 for performing actions based on a particular intent, the user of computing device 110 may instead prefer to use a different agent module 128 for performing actions based on the particular intent and therefore rank the preferred agent of the user higher than the agent most other users prefer.

Assistant module 122A may determine whether to recommend that assistant module 122A or the recommended agent module 128 perform the one or more actions associated with the image data (306). For example, in some cases, assistant module 122A may be a recommended agent for performing an action based at least in part on image data whereas one of agent modules 128 may be the recommended agent. Assistant module 122A may rank assistant module 122A in amongst the one or more agent modules 128 and select either the highest-ranking agent (e.g., either assistant module 122A or agent module 128) perform an action based on an inferred intent from image data received from camera 114. For example, assistant module 122A and agent module 128aA may each be agents configured to order movie tickets, view movie trailers, or rent movies. Assistant module 122A may compare the quality scores associated with assistant modules 122A and agent module 128aA to determine which to recommend for performing an action related to the movie poster.

Responsive to determining to recommend that assistant module 122A perform the one or more actions associated with the image data (306, assistant), assistant module 122A may cause assistant module 122A to perform the action (308). For example, assistant module 122A may cause UI module 120 to output, via UID 112, a user interface requesting user input for whether the user wants to purchase tickets to see a showing of the particular movie in the movie poster or view a trailer of the movie in the poster.

Responsive to determining to recommend that the recommended agent perform the one or more actions associated with the image data (306, agent), assistant module 122A may output an indication of the recommended agent (310). For example, assistant module 122A may cause UI module 120 to output an audible, visual, and/or haptic notification via UID 112 indicating that, based at least in part on image data captured by camera 114, assistant module 122A is recommending the user interact with agent module 128aA to help the user perform an action at a current time. The notification may include an indication that assistant module 122A has inferred from the image data the user may be interested in movies or the particular movie in the poster and may inform the user that agent module 128aA can help answer questions, show a trailer, or even order movie tickets.

In some examples, the recommended agent may be more than one recommended agent. In such a case, assistant module 122A may output as part of the notification, a request for the user to choose a particular recommended agent.

Assistant module 122A may receive user input confirming the recommended agent (312). For example, after outputting the notification, the user may provide touch input at UID 112 or voice input to UID 112 confirming that the user wishes to use the recommended agent to order movie tickets or see a trailer of the movie in the movie poster.

Unless assistant module 122A receive such user confirmation, or other explicit consent, assistant module 122A may refrain from outputting any image data captured by camera 114 to any of modules 128A. To be clear, assistant modules 122 may refrain from making use of, or analyzing any personal information of a user or computing device 110, including image data capture by camera 114, unless assistant modules 122 receive explicit consent from the user to do so. Assistant modules 122 may also provide an opportunity for the user to withdraw or remove consent.

In any case, responsive to receiving the user input confirming the recommended agent, assistant module 122A may cause the recommended agent to at least initiate performance of the one or more actions associated with the image data (314). For example, assistant module 122A receives information confirming the user wishes to use the recommended agent to perform an action on the image data obtained by camera 114, assistant module 122A may send the image data captured by camera 114 to the recommended agent with instructions to process the image data and take any appropriate actions. For instance, assistant module 122A may send the image data captured by camera 114 to agent module 128aA or may launch an application executing at computing device 110 that is associated with agent module 128aA. Agent module 128AaA may perform its own analysis on the image data, open a website, trigger an action, start a conversation with the user, show a video, or perform any other related action using the image data. For instance, agent module 128aA may perform its own image analysis on the image data of the movie poster, determine the particular movie, and output a notification via UI module 120 and UID 112 asking the user if he or she wants to view a trailer of the movie.

More generally, “causing the recommended agent to perform actions” may include an assistant, such as assistant module 122A invoking the 3P agent. In such a case, in order to perform a task or operation, the 3P agent may still require further user action, such as approval, entering payment info, etc. Of course, causing the recommended agent to perform the action may also cause 3P agent to perform an action without requiring further user action in some cases.

In some examples, assistant module 122A may cause the recommended agent to at least initiate performance of the one or more actions associated with image data by enabling the recommended 3P agent to determine information or generate results associated with the one or more actions, or start but not fully complete and action, and then allow assistant module 122A to share the results with the user or complete the actions. For example, a 3P agent may receive all of the details of a pizza order (e.g., quantity, type, toppings, address, time, delivery/carryout, etc.) after being initiated by assistant module 122A and then hand control back to assistant module 122A to cause assistant module 122A finish the order. For instance, the 3P agent may cause computing device 110 to output at UIC 112 an indication of “We'll now get you back to <1P assistant> to finish up this order.” In this way, the 1P assistant may handle the financial details of the order so that the user's credit card or the like is not shared. In other words, in accordance with techniques described herein, a 3P may perform some of an action and then hand off control back to a 1P assistant to complete or further an action.

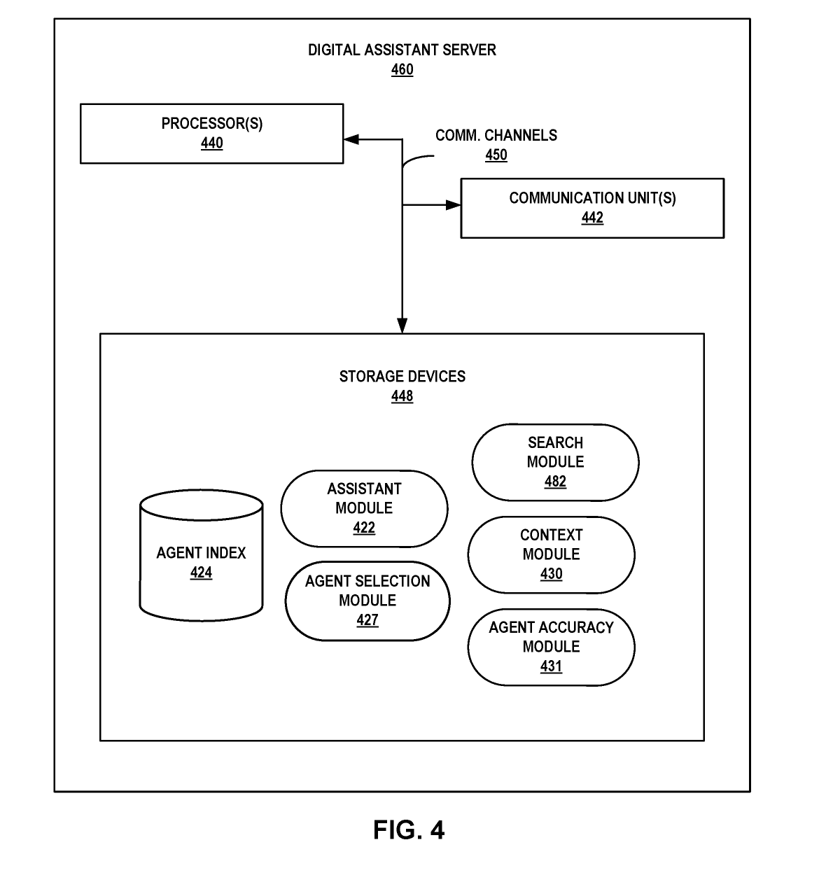

FIG. 4 is a block diagram illustrating an example computing system that is configured to execute an example assistant, in accordance with one or more aspects of the present disclosure. Digital assistant server 460 of FIG. 4 is described below as an example of digital assistant server 160 of FIG. 1. FIG. 4 illustrates only one particular example of digital assistant server 460, and many other examples of digital assistant server 460 may be used in other instances and may include a subset of the components included in example digital assistant server 460 or may include additional components not shown in FIG. 4.

As shown in the example of FIG. 4, digital assistant server 460 includes user one or more processors 440, one or more communication units 442, and one or more storage components 448. Storage components 448 include assistant module 422, agent selection module 427, agent accuracy module 431, search module 482, context module 430, and user agent index 424.

Processors 440 are analogous to processors 240 of computing system 210 of FIG. 2. Communication units 442 are analogous to communication units 242 of computing system 210 of FIG. 2. Storage devices 448 are analogous to storage devices 248 of computing system 210 of FIG. 2. Communication channels 450 are analogous to communication channels 250 of computing system 210 of FIG. 2 and may therefore interconnect each of the components 440, 442, and 448 for inter-component communications. In some examples, communication channels 450 may include a system bus, a network connection, an inter-process communication data structure, or any other method for communicating data.

Search module 482 of digital assistant server 460 is analogous to search module 282 of computing device 210 and may perform integrated search functions on behalf of digital assistant server 460. That is, search module 482 may perform search operations on behalf of assistant module 422. In some examples, search module 482 may interface with external search systems, such as search system 180 to perform search operations on behalf of assistant module 422. When invoked, search module 482 may perform search functions, such as generating search queries and executing searches based on generated search queries across various local and remote information sources. Search module 482 may provide results of executed searches to the invoking component or module. That is, search module 482 may output search results to assistant module 422.

Context module 430 of digital assistant server 460 is analogous to context module 230 of computing device 210. Context module 430 may collect contextual information associated with computing devices, such as computing device 110 of FIG. 1 and computing device 210 of FIG. 2, to define a context of the computing device. Context module 430 may primarily be used by assistant module 422 and/or search module 482 to define a context of a computing device interfacing and accessing a service provided by digital assistant server 160. The context may specify the characteristics of the physical and/or virtual environment of the computing device and a user of the computing device at a particular time.

Agent selection module 427 is analogous to agent selection module 227 of computing device 210.

Assistant module 422 may include all functionality of assistant module 122A and assistant module 122B of FIG. 1, as well as assistant module 222 of computing device 210 of FIG. 2. Assistant module 422 may perform similar operations as assistant module 122B for providing an assistant service that is accessible vian assistant server 460. That is, assistant module 422 may act as an interface to a remote assistance service accessible to a computing device that is communicating over a network with digital assistant server 460. For example, assistant module 422 may be an interface or API to remote assistance module 122B of digital assistant server 160 of FIG. 1.

Similar to agent index 224 of FIG. 2, agent index 424 may store information related to agents, such as 3P agents. Assistant module 422 and/or agent selection module 427 may rely on the information stored at agent index 424, in addition to any information provided by context module 430 and/or search module 482, to perform assistant tasks and/or select agents to perform an action or complete a task inferred from image data.

In accordance with one or more techniques of this disclosure, agent accuracy module 431 may gather additional information about agents. In some examples, agent accuracy module 431 may be considered to be an automated agent crawler. For instance, agent accuracy module 431 may query each agent and store the information it receives. As one example, agent accuracy module 431 may send a request to the default agent entry point and will receive back a description from the agent about its capabilities. Agent accuracy module 431 may store this received information in agent index 424 (i.e., to improve targeting).

In some examples, digital assistant server 460 may receive inventory information for agents, where applicable. As one example, an agent for an online grocery store can provide digital assistant server 460 a data feed (e.g., a structured data feed) of their products, including description, price, quantities, etc. An agent selection module (e.g., agent selection module 224 and/or agent selection module 424) may access this data as part of selecting an agent to satisfy a user's utterance. These techniques may enable the system to better respond to queries such as “order a bottle of prosecco”. In such a situation, an agent selection module can match image data to an agent more confidently if the agent has provided their real-time inventory and the inventory indicated that the agent sells prosecco and has prosecco in stock.

In some examples, digital assistant server 460 may provide an agent directory that users may browse to discover/find agents that they might like to use. The directory may have a description of each agent, a list of capabilities (in natural language; e.g., “you can use this agent to order a taxi”, “you can use this agent to find food recipes”). If the user finds an agent in the directory that they would like to use, the user may select the agent and the agent may be made available to the user. For instance, assistant module 422 may add the agent into agent index 224 and or agent index 424. As such, agent selection module 227 and/or agent selection module 427 may select the added agent to satisfy future utterances. In some examples, one or more agents may be added into agent index 224 or agent index 424 without user selection. In some of such examples, agent selection module 227 and/or agent selection module 427 may be able to select and/or suggest agents that have not been selected by a user to perform actions based at least in part on image data. In some examples, agent selection module 227 and/or agent selection module 427 may further rank agents based on whether they were selected by the user.

In some examples, one or more of the agents listed in the agent directory may be free (i.e., provided at no cost). In some examples, one or more of the agents listed in the agent directory may not be free (i.e., the user may have to pay money or some other consideration in order to use the agent).

In some examples, the agent directory may collect user reviews and ratings. The collected user reviews and ratings may be used to modify the agent quality scores. As one example, when an agent receives positive reviews and/or ratings, agent accuracy module 431 may increase the agent's popularity score or agent quality score in agent index 224 or agent index 424. As another example, when an agent receives negative reviews and/or ratings, agent accuracy module 431 may decrease the agent's popularity score or agent quality score in agent index 224 or agent index 424.

It will be appreciated that improved operation of a computing device is obtain according to the above description. For example, by identifying a preferred agent to execute a task provided by a user, generalized searching and complex query rewriting can be reduced. This in turn reduces use of bandwidth and data transmission, reduces use of temporary volatile memory, reduces battery drain, etc. Furthermore, in certain embodiments, optimizing device performance and/or minimizing cellular data usage can be highly weighted features for ranking agents, such that selection of an agent based on these criteria provides the desired direct improvements in device performance and/or reduced data usage.

Clause 1. A method comprising: receiving, by an assistant accessible by a computing device, image data from a camera of the computing device; selecting, by the assistant, based on the image data and from a plurality of agents accessible by the computing device, a recommended agent to perform one or more actions associated with the image data; determining, by the assistant, whether to recommend that the assistant or the recommended agent perform the one or more actions associated with the image data; responsive to determining to recommend that the recommended agent perform the one or more actions associated with the image data, causing, by the assistant, the recommended agent to perform the one or more actions associated with the image data.

Clause 2. The method of clause 1, further comprising: prior to selecting the recommended agent to perform one or more actions associated with the image data: receiving, by the assistant, from each particular agent from the plurality of agents, a registration request that includes one or more respective intents associated that particular agent; and registering, by the assistant, each particular agent from the plurality of agents with the one or more respective intents associated that particular agent.

Clause 3. The method of clause 2, wherein selecting the recommended agent comprises: selecting the recommended agent responsive to determining that the recommended agent is registered with one or more intents inferred from the image data.

Clause 4. The method of any one of clauses 1-3, wherein selecting the agent further comprises: inferring one or more intents from the image data: identifying, from the plurality of agents, one or more agents that are registered with at least one of the one or more intents; determining, based on information related to each of the one or more agents and the one or more intents, a ranking of the one or more agents; and selecting, based at least in part on the ranking, from the plurality of agents, the recommended agent.

Clause 5. The method of clause 4, wherein the information related to a particular agent from the one or more agents includes at least one of: a popularity score of the particular agent, a relevancy score between the particular agent and the image data, a usefulness score between the particular agent and the image data, an importance score associated with each of the one or more intents that are associated with the particular agent, a user satisfaction score associated with the particular agent, and a user interaction score associated with the particular agent.

Clause 6. The method of any one of clauses 4 or 5, wherein determining the ranking of the one or more agents comprises: inputting, by the assistant, into a machine learning system, the information related to each of the one or more agents and the one or more intents; receiving, by the assistant, from the machine learning system, a respective score for each of the one or more agents; and determining, based on the respective score for each of the one or more agents, the ranking of the one or more agents.

Clause 7. The method of clause 6, where demining whether to recommend that the assistant or the recommended agent perform the one or more actions associated with the image data comprises: inputting, by the assistant, into the machine learning system, information related to the assistant and the one or more intents; receiving, by the assistant, from the machine learning system, a score for the assistant; determining whether the respective score for a highest-ranking agent from the one or more agents exceeds the score of the assistant; responsive to determining that the respective score for the highest ranking agent from the one or more agents exceeds the score of the assistant, determining, by the assistant to recommend that the highest ranking agent perform the one or more actions associated with the image data.

Clause 8. The method of any one of clauses 4-7, wherein determining the ranking of the one or more agents further comprises inputting, by the assistant, into a machine learning system, contextual information associated with the computing device.

Clause 9. The method of any one of clauses 1-8, wherein causing the recommended agent to perform the one or more actions associated with the image data comprises outputting, by the assistant, to a remote computing system associated with the recommended agent, at least a portion of the image data to cause the remote computing system associated with the recommended agent to perform the one or more actions associated with the image data.

Clause 10. The method of any one of clauses 1-9, wherein causing the recommended agent to perform the one or more actions associated with the image data comprises outputting, by the assistant, a request on behalf of the recommended agent for user input associated with at least a portion of the image data.

Clause 11. The method of any one of clauses 1-10, wherein causing the recommended agent to perform the one or more actions associated with the image data comprises causing, by the assistant, the recommended agent to launch an application from the computing device to perform the one or more actions associated with the image data, wherein the application is different than the assistant.

Clause12. The method of any one of clauses 1-11, wherein each agent from the plurality of agents is a third-party agent associated with a respective third-party service that is accessible from the computing device.

Clause 13. The method of clause 12, wherein the respective third-party service associated with each of the plurality of agents is different from services provided by the assistant.

Clause 14. A computing device comprising: a camera; an output device; an input device; at least one processor; and a memory storing instructions that, when executed, cause the at least one processor to execute an assistant that is configured to: receive image data from the camera; select, based on the image data and from a plurality of agents accessible from the computing device, a recommended agent to perform one or more actions associated with the image data; determine whether to recommend that the assistant or the recommended agent perform the one or more actions associated with the image data; responsive to determining to recommend that the recommended agent perform the one or more actions associated with the image data, cause the recommended agent to perform the one or more actions associated with the image data.

Clause 15. The computing device of clause 14, wherein the assistant that is further configured to: prior to selecting the recommended agent to perform one or more actions associated with the image data: receive, from each particular agent from the plurality of agents, a registration request that includes one or more respective intents associated that particular agent; and register each particular agent from the plurality of agents with the one or more respective intents associated that particular agent.

Clause 16. The computing device of any one of clauses 14 or 15, wherein the assistant that is further configured to select the recommended agent responsive to determining that the recommended agent is registered with one or more intents inferred from the image data.

Clause 17. The computing device of any one of clauses 14-16, wherein the assistant that is further configured to select the recommended agent by at least: inferring one or more intents from the image data: identify, from the plurality of agents, one or more agents that are registered with at least one of the one or more intents; determine, based on information related to each of the one or more agents and the one or more intents, a ranking of the one or more agents; and select, based at least in part on the ranking, from the plurality of agents, the recommended agent.

Clause 18. The computing device of clause 17, wherein the information related to a particular agent from the one or more agents includes at least one of: a popularity score of the particular agent, a relevancy score between the particular agent and the image data, a usefulness score between the particular agent and the image data, an importance score associated with each of the one or more intents that are associated with the particular agent, a user satisfaction score associated with the particular agent, and a user interaction score associated with the particular agent.

Clause 19. A computer-readable storage medium comprising instructions that, when executed by at least one processor of a computing device, provide an assistant that is configured to: receive image data; select, based on the image data and from a plurality of agents accessible from the computing device, a recommended agent to perform one or more actions associated with the image data; determine whether to recommend that the assistant or the recommended agent perform the one or more actions associated with the image data; responsive to determining to recommend that the recommended agent perform the one or more actions associated with the image data, cause the recommended agent to perform the one or more actions associated with the image data.

Clause 20. The computer-readable storage medium of clause 19, wherein the assistant is further configured to: prior to selecting the recommended agent to perform one or more actions associated with the image data: receive, from each particular agent from the plurality of agents, a registration request that includes one or more respective intents associated that particular agent; and register each particular agent from the plurality of agents with the one or more respective intents associated that particular agent.

Clause 21. A system comprising means for performing any one of the methods of clauses 1-13.

In one or more examples, the functions described may be implemented in hardware, software, firmware, or any combination thereof If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

1. A method comprising:
receiving, by an assistant accessible by a computing device, image data from an image sensor in communication with the computing device;
selecting, by the assistant, based on the image data and from a plurality of agents accessible by the computing device, a recommended agent to perform one or more actions associated with the image data;
determining, by the assistant, whether to recommend that the assistant or the recommended agent perform the one or more actions associated with the image data;
responsive to determining to recommend that the recommended agent perform the one or more actions associated with the image data, causing, by the assistant, the recommended agent to at least initiate performance of the one or more actions associated with the image data.

2. The method of claim 1, further comprising:
prior to selecting the recommended agent to perform one or more actions associated with the image data:
receiving, by the assistant, from each particular agent from the plurality of agents, a registration request that includes one or more respective intents associated that particular agent; and
registering, by the assistant, each particular agent from the plurality of agents with the one or more respective intents associated that particular agent.

3. The method of claim 2, wherein selecting the recommended agent comprises:
selecting the recommended agent responsive to determining that the recommended agent is registered with one or more intents inferred from the image data.

4. The method of claim 1, wherein selecting the agent further comprises:
inferring one or more intents from the image data:
identifying, from the plurality of agents, one or more agents that are registered with at least one of the one or more intents;
determining, based on information related to each of the one or more agents and the one or more intents, a ranking of the one or more agents; and
selecting, based at least in part on the ranking, from the plurality of agents, the recommended agent.

5. The method of claim 4, wherein the information related to a particular agent from the one or more agents includes at least one of: a popularity score of the particular agent, a relevancy score between the particular agent and the image data, a usefulness score between the particular agent and the image data, an importance score associated with each of the one or more intents that are associated with the particular agent, a user satisfaction score associated with the particular agent, and a user interaction score associated with the particular agent.

6. The method of claim 4, wherein determining the ranking of the one or more agents comprises:
inputting, by the assistant, into a machine learning system, the information related to each of the one or more agents and the one or more intents;
receiving, by the assistant, from the machine learning system, a respective score for each of the one or more agents; and
determining, based on the respective score for each of the one or more agents, the ranking of the one or more agents.

7. The method of claim 6, where demining whether to recommend that the assistant or the recommended agent perform the one or more actions associated with the image data comprises:
inputting, by the assistant, into the machine learning system, information related to the assistant and the one or more intents;
receiving, by the assistant, from the machine learning system, a score for the assistant;
determining whether the respective score for a highest-ranking agent from the one or more agents exceeds the score of the assistant;
responsive to determining that the respective score for the highest ranking agent from the one or more agents exceeds the score of the assistant, determining, by the assistant to recommend that the highest ranking agent perform the one or more actions associated with the image data.

8. The method of claim 4, wherein determining the ranking of the one or more agents further comprises inputting, by the assistant, into a machine learning system, contextual information associated with the computing device.

9. The method of claim 1, wherein causing the recommended agent to perform the one or more actions associated with the image data comprises outputting, by the assistant, to a remote computing system associated with the recommended agent, at least a portion of the image data to cause the remote computing system associated with the recommended agent to perform the one or more actions associated with the image data.

10. The method of claim 1, wherein causing the recommended agent to initiate performance of the one or more actions associated with the image data comprises outputting, by the assistant, a request on behalf of the recommended agent for user input associated with at least a portion of the image data.

11. The method of claim 1, wherein causing the recommended agent to initiate performance of the one or more actions associated with the image data comprises causing, by the assistant, the recommended agent to launch an application from the computing device to perform the one or more actions associated with the image data, wherein the application is different than the assistant.

12. The method of claim 1, wherein each agent from the plurality of agents is a third-party agent associated with a respective third-party service that is accessible from the computing device.

13. The method of claim 12, wherein the respective third-party service associated with each of the plurality of agents is different from services provided by the assistant.

14. A computing device comprising:
a camera;
an output device;
an input device;
at least one processor; and
a memory storing instructions that, when executed, cause the at least one processor to execute an assistant that is configured to:
receive image data from the camera;
select, based on the image data and from a plurality of agents accessible from the computing device, a recommended agent to perform one or more actions associated with the image data;
determine whether to recommend that the assistant or the recommended agent perform the one or more actions associated with the image data;
responsive to determining to recommend that the recommended agent perform the one or more actions associated with the image data, cause the recommended agent to initiate performance of the one or more actions associated with the image data.

15. The computing device of claim 14, wherein the assistant that is further configured to:
prior to selecting the recommended agent to perform one or more actions associated with the image data:
receive, from each particular agent from the plurality of agents, a registration request that includes one or more respective intents associated that particular agent; and
register each particular agent from the plurality of agents with the one or more respective intents associated that particular agent.

16. The computing device of claim 14, wherein the assistant that is further configured to select the recommended agent responsive to determining that the recommended agent is registered with one or more intents inferred from the image data.

17. The computing device of claim 14, wherein the assistant that is further configured to select the recommended agent by at least:
inferring one or more intents from the image data:
identify, from the plurality of agents, one or more agents that are registered with at least one of the one or more intents;
determine, based on information related to each of the one or more agents and the one or more intents, a ranking of the one or more agents; and
select, based at least in part on the ranking, from the plurality of agents, the recommended agent.

18. The computing device of claim 17, wherein the information related to a particular agent from the one or more agents includes at least one of: a popularity score of the particular agent, a relevancy score between the particular agent and the image data, a usefulness score between the particular agent and the image data, an importance score associated with each of the one or more intents that are associated with the particular agent, a user satisfaction score associated with the particular agent, and a user interaction score associated with the particular agent.

19. A computer-readable storage medium comprising instructions that, when executed by at least one processor of a computing device, provide an assistant that is configured to:
receive image data;
select, based on the image data and from a plurality of agents accessible from the computing device, a recommended agent to perform one or more actions associated with the image data;
determine whether to recommend that the assistant or the recommended agent perform the one or more actions associated with the image data;
responsive to determining to recommend that the recommended agent perform the one or more actions associated with the image data, cause the recommended agent to initiate performance of the one or more actions associated with the image data.

20. The computer-readable storage medium of claim 19, wherein the assistant is further configured to:
prior to selecting the recommended agent to perform one or more actions associated with the image data:
receive, from each particular agent from the plurality of agents, a registration request that includes one or more respective intents associated that particular agent; and
register each particular agent from the plurality of agents with the one or more respective intents associated that particular agent.
